(19) United States
(12) Patent Application Publication
(10) Pub. No.: US 2020/0405075 A1
(43) Pub. Date: Dec. 31, 2020

(54) AUTOMATED BULK PRODUCT DISPENSER

(71) Applicant: The Aggressive Good Inc., Ottawa (CA)

(72) Inventors: Geoffrey D.C. MACKAY, Ottawa (CA); Christopher FALCONI, Ottawa (CA)

(21) Appl. No.: 16/912,989

(22) Filed: Jun. 26, 2020

(30) Foreign Application Priority Data
Jun. 28, 2019 (CA) 3048200

(51) Int. Cl. A47F 1/035; A47F 10/02; G06Q 30/06; G07F 9/02; G07F 11/44

(52) U.S. Cl. CPC A47F 1/035; A47F 10/02; A47F 2010/005; G07F 9/026; G07F 11/44; G06Q 30/06

(57) ABSTRACT

An automated dispensing system that releases a selected quantity of an edible or non-edible bulk product is provided. Using a digital interface or a dispense button, consumers select a specified amount of bulk product to be dispensed (by weight, mass, or cost). The product is then dispensed into a receptacle container and the system calculates the quantity and corresponding cost that was dispensed into the receptacle container. Using an identification key system, consumers can activate the automatic dispensing system. The identification key may be used to track and store the user's dispensed bulk products. This information may be uploaded to a database that is later called upon at the time of checkout to tabulate the users total cost of dispensed bulk products. The system can also update an inventory database of the bulk products.

### TECHNICAL FIELD

The present disclosure relates to bulk product dispensing methods, and in particular to an automated bulk food dispensing apparatus and method.

### BACKGROUND ART

Bulk food purchasing is very common in retail and grocery shops. Currently bulk food purchasing in stores is manual. A consumer scoops, weighs, tags, and identifies their bulk food products using plastic or paper tags and weight scales in the stores. In some cases the consumer may not weigh the bulk product until reaching the cash register. This process leads to inaccurate and inefficient weighing methods. The current purchasing system for bulk products can lead to errors caused by the user, and inventory control may be compromised for the retailer. The current process can be time consuming and inaccurate as each step of the process is manually performed by the user. The current process can also be wasteful, and may lead to cross contamination of food due to bacteria. In addition, the consumer does not have any instant information about cost or quantity of the bulk food product they are purchasing. The current purchasing systems for bulk products leave the consumer with unknown quantities of the product until they reach the cash register, which means they may over or under spend unknowingly.

The current bulk food purchasing systems require the user to scoop an unknown amount of product into a plastic or paper bag. This bag is usually thrown away once the consumer is done with bulk food product they have scooped into it. To perform the current bulk food purchasing system in stores, the consumer must scoop the product from an open bin into the plastic or paper bag, seal the bag by tying a knot or using a tag, and then record the product code on the tag with a small pencil. During this process, the consumer is unaware of the final price or weight of the product they have just scooped into the plastic or paper bag. Plastic waste and food waste are problems in many systems with no current solutions for bulk product purchasing systems.

Accordingly, an additional, alternative, and/or improved bulk product dispensing system is desired.

### SUMMARY

In accordance with one aspect of the present disclosure, a method of automatically dispensing a bulk product is disclosed, the method comprising: receiving an indication to dispense bulk product; measuring a weight of a bulk product bin before dispensing; automatically dispensing at least a portion of the bulk product from the bulk product bin; measuring a weight of the bulk product bin after dispensing; and displaying a difference between the weight of the bulk product bin before dispensing and the weight of the bulk product bin after dispensing to a display.

The method may further comprise receiving identification information identifying the user.

The method may further comprise storing the difference and the identification information to a database.

In the method, the indication to dispense bulk product may include an amount of the bulk product to be dispensed.

In the method, the amount of the bulk product may be provided in one or more of weight, mass, volume, and cost, and the method further comprises automatically converting the amount of bulk product to be dispensed into a weight or mass of the bulk product to be dispensed.

In the method, the difference may be transmitted to a database for updating an inventory of the bulk product.

The method may further comprise: automatically converting the difference into a corresponding cost for the at least a portion of the bulk product; storing the difference and the corresponding cost to a database; and displaying the cost on the display.

In the method, the cost and the difference may be transmitted and stored on the database to update an inventory of the bulk product.

In accordance with an aspect of the present disclosure, an automatic dispensing apparatus is provided, the apparatus comprising circuitry configured to perform the above method.

In accordance with another aspect of the present disclosure, a system for automatically dispensing bulk product is provided, the system comprising: a receiver for receiving an indication to dispense the bulk product; a scale for measuring a weight of a bin storing the bulk product; a dispenser for automatically dispensing at least a portion of the bulk product into a container; and a processor for determining a difference between the weight of the bin and the weight of the bin after the bulk product is dispensed, and displaying the difference to a display.

The system may further comprise a storage means for storing the difference.

In the system, the receiver may receive identification information. The identification information identifying a user.

In the system, the difference may be stored together with the identification information.

In the system, the indication may include an amount of bulk product to be dispensed by the dispenser.

In the system, the amount may be provided in a unit of measure, and the processor may be further configured to automatically convert the amount into a weight or mass of the bulk product to be dispensed.

In accordance with another aspect of the present disclosure, a checkout system for automatically dispensed bulk product is provided, the system comprising: a retrieving unit for retrieving information, from a database, about at least one dispensed bulk product associated with a user, the information comprising a cost of each of the at least one dispensed bulk product; and a processor for determining a total cost of the at least one dispensed bulk product based on the cost of each of the at least one dispensed bulk product, and displaying the total cost to a display.

In the system, the information may further comprise a type of the at least one bulk product and an amount of the at least one bulk product.

The system may further comprise a receiver for receiving an indication from an identification key of the user to retrieve the information.

In accordance with yet another aspect of the present disclosure, an apparatus is provided, the apparatus comprising: a bulk product bin configured to store bulk product; a dispensing chamber removably attached to the bulk product bin and configured to dispense at least a portion of the bulk product; a scale at a bottom of the bulk product bin to measure a weight of the bin before and after the at least a portion of the bulk product has been dispensed.

In the apparatus, the dispensing chamber may comprise a valve system for dispensing the at least a portion of the bulk product.

In the apparatus, the dispensing chamber may comprise an auger system for dispensing the at least a portion of the bulk product.

The apparatus may further comprise a display configured to display a difference between the weight of the bin before and the weight of the bin after the at least a portion of the bulk product has been dispensed.

### BRIEF DESCRIPTION OF DRAWINGS

Further features and advantages of the present disclosure will become apparent from the following detailed description, taken in combination with the appended drawings, in which:

FIGS. 1A and 1B depict an embodiment of the automated bulk product dispensing system;

FIGS. 2A and 2B depict a removable cartridge of the automatic dispenser;

FIG. 3 depicts a motor using a male/female coupler of the automatic dispenser;

FIGS. 4A-4D depict the automatic dispenser in open and closed positions;

FIGS. 5A and 5B depicts an embodiment of the automatic dispenser;

FIGS. 6A and 6B depict a display of the automatic dispenser;

FIG. 7 depicts an embodiment of the display of the automatic dispenser;

FIG. 8 depicts dispensing options on the display of the automatic dispenser;

FIG. 9 depicts a system for selecting a desired amount of bulk product;

FIG. 10 depicts a dispensing system of the automatic dispenser; and

FIG. 11 depicts a dispensing system using an identification key.

### DETAILED DESCRIPTION

An automated bulk product dispensing system is described. The system may receive an indication to dispense bulk product and automatically dispense a desired amount of the bulk product. The weight or mass of the dispensed bulk product is measured or calculated as the product is being dispensed into a receptacle container. The weight or mass of the dispensed bulk product may then be transmitted to a server for payment purposes and/or for updating bulk product inventories. The dispensing system is an automated system that does not require pencils and paper or plastic tags.

The automated bulk food/product dispenser releases a desired quantity of product (ex. sugar, snacks, baking goods, rice, flour powder, liquid, semi solid liquids or foods, pet food, hard goods, etc.) by dispensing the desired quantity accurately and efficiently. The consumer may use their own receptacle container or bag to store their dispensed bulk product or the receptacle container may be provided by the retailer. The receptacle container may be a reusable plastic container, a glass container, a plastic or paper bag, or another type of reusable container. This system promotes the use of reusable containers and bags to prevent unnecessary waste.

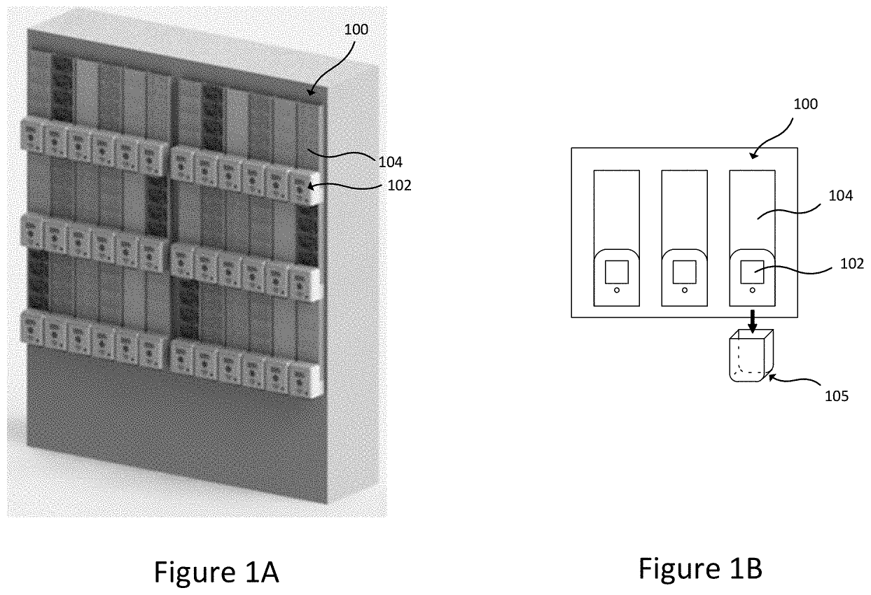

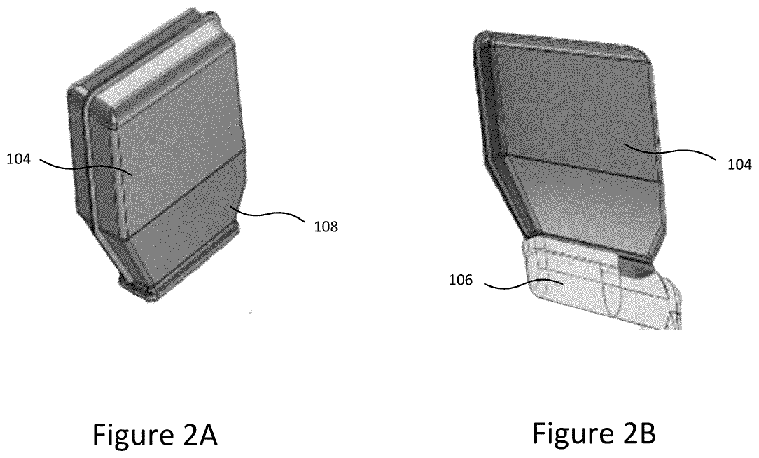

FIG. 1A and FIG. 1B depict an embodiment of the automated bulk product dispensing system. The system may comprise one or more automatic bulk product dispensers 100 each dispenser containing a different bulk product to be dispensed. The automatic dispenser comprises a display 102 and a cartridge 104. The cartridge 104 stores the bulk product that is to be dispensed into a user's receptacle container 105. The cartridge 104 may be a removable cartridge as shown in FIGS. 2A and 2B that allows for easy removal of the cartridge 104, refilling of the bulk product, replacement of the cartridge 104, and for easy cleaning of the cartridge 104. The cartridge 104 may be a sealable container or bin that may be made of food grade acrylic, a food safe plastic, or another food safe type of material. The cartridge 104 of the automated dispenser 100 allows for a better protected food environment, wherein the bulk product is always sealed in a bin, such as the cartridge 104, so that there is no cross contamination or mess, thus reducing any product from being wasted. This means that consumers with food allergies may shop for bulk dispensed products without worrying about a potential allergic reaction due to cross contamination of the different bulk products. The cartridge 104 may have a single or several cavities that can be sealed by the supplier with a vacuum seal or with a removable lid.

The cartridge 104 may removably connect to an auger chamber 106, so that the auger chamber 106 is placed below the cartridge 104. This may allow the bulk product to be guided with gravitational forces towards the auger chamber 106 when the bulk product is being dispensed. Although the cartridge 104 is depicted as being at the top of the automatic dispenser 100, the cartridge 104 may be placed on the sides or at the bottom of the automatic dispenser 100 and a motorized system may be used to guide the product toward the auger chamber 106. The cartridge 104 may comprise an opening at a bottom side that provides the removable connection to the auger chamber 106. The auger chamber 106 may slide onto the opening of the cartridge 104 to form a secure connection between the auger chamber 106 and the cartridge 104.

The auger chamber 106 uses an auger to allow for efficient and controlled dispensing of the bulk product. The product may be guided to the auger chamber 106 via a gravity feed system 108. The gravity feed system 108 may be a funnel shape at a bottom or side of the cartridge 106, a funnel placed on a bottom or side of the cartridge 106, a motorized system, or another guiding type mechanism.

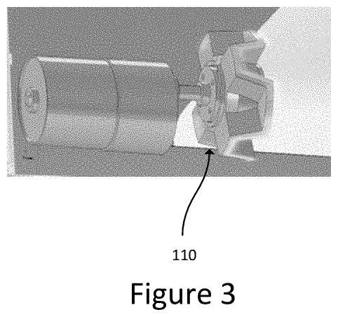

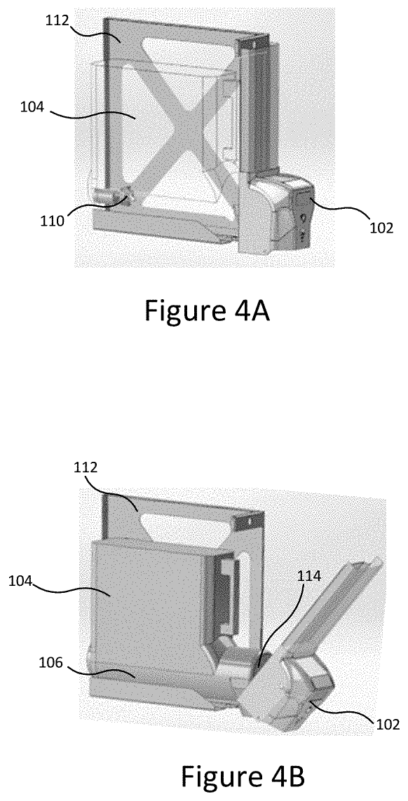

Once the auger chamber 106 is connected or fastened to the cartridge 104, the combination is connected to motor using a male/female coupler 110 shown in FIG. 3. Referring to FIG. 4A through 4D, the motor and coupler 110 may be housed in a frame 112 of the automatic dispenser 100. The auger in the auger chamber 106 may be rotated by the motor to facilitate dispensing of the product. The motor may be a geared stepper motor that may be used with a planetary gearbox to provide power to the auger for the rotation. The motor engages rotation of the auger to push the bulk product towards the receptacle container 105. The rotation of the auger promotes the flow of the bulk product towards the end funnel 114 and into the user's receptacle container 105. The receptacle container 105 is placed below and close to the end funnel 114 to receive the dispensed product. The receptacle container 105 may be held in a position below the end funnel 114 by a user, or the receptacle container 105 may be placed on a platform on the dispenser 100, as further described below.

The auger's specifications may vary depending on the type of bulk product to be dispensed. The retailer may have multiple augers with varying thread sizes to accommodate the different bulk product types. Augers of different thread sizes may be interchangeable in the automatic dispenser 100 to accommodate the different granularities of the different bulk product types. A retailer may have many automated dispensers 100 (as shown in FIG. 1), each using a different auger thread size. The auger, whose rotation is controlled by the motor, is used to control the speed and quantity of product that flows through to an end funnel 114. The motor may have a predetermined RPM to run at to ensure accurate amounts of bulk product are dispensed for accurate calculations of cost and accurate weight or mass measurements. The end funnel 114 may be placed at an end of the auger to allow the flow of the bulk product from the auger to the consumer's receptacle container 105.

FIGS. 4A-4D depict the automatic dispenser 100 in open and closed positions. FIG. 4A depicts the automatic dispenser 100 in a closed, dispensing position. The cartridge 104 is depicted as a clear cartridge to show the connection of the cartridge 104 and auger chamber 106 to coupler 110 in the frame 112 of the automatic dispenser 100. FIG. 4B shows the automatic dispenser 100 being moved to an open position. In the open position, the cartridge 104 and the auger chamber 106 may be removed from the frame 112 so that the cartridge 104 may be refilled if the bulk product is running low, may be replaced, so that the auger may be changed to an auger with a different thread, and/or so that the cartridge 104 and auger chamber 106 may be cleaned.

The automatic dispenser 100 may be moved from closed to open positions by opening or unlocking a securing means on the frame 112 of the automatic dispenser 100. The securing means may be a lock and key, a snap mechanism, a sensor mechanism or any other type of securing means. In an embodiment, the securing means is a means that can only be opened or locked by authorized personnel at the location of the automatic dispensing system. This may ensure that no consumer or user can open the automatic dispenser 100 without authorization from the retailer. This can prevent theft of the bulk product and only allow the bulk product to be dispensed using the automatic dispensing system.

Although the automatic dispenser 100 is depicted as using an auger to dispense the bulk product, it will be appreciated that a valve system may be used instead of the auger system. The valve system may be used to enable liquids and semi solids to be dispensed using the same interface and transaction method of the automatic dispenser 100. The valve may be powered and controlled by the motor in the frame 112. The motor may engage opening of the valve to release the product towards end funnel 114 and to the receptacle container 105. The valve system may release liquid once the system receives an indication to dispense the bulk product, and the mass or weight of the dispensed liquid may be measured or calculated in real-time as the product is being dispensed into a receptacle container 105. The weight or mass of the dispensed bulk product may then be transmitted to a database for payment purposes and/or for updating bulk product inventories.

The mass or weight of the dispensed product is measured or calculated in real-time using a scale which may be housed in the frame 112 of the automatic dispenser 100. The scale may be used to weigh the bulk product before, during, and after dispensing. The scale may weigh the cartridge 104 using load sensors placed between the cartridge 104 and the frame 112. One or more sensors may be used in order to accurately capture the weight changes that occur when dispensing the bulk product. The sensor itself can be based on any available load monitoring technology, such as a load cell, compressive foam, linear variable transformer, and more, that are wired or wirelessly connected to the processor. It will be appreciated that another location may be chosen for the scale provided the sensors are able to accurately and consistently measure weight changes as bulk product is dispensed. Other locations may include, but are not limited to, sensors placed between the floor and the automatic dispenser for a free standing setup, between the ceiling and the automatic dispenser for a suspended setup, and/or between the wall and the automatic dispenser for a wall mounted system.

The scale provides a weight measurement of the cartridge 104, that stores the bulk product, before the bulk product is dispensed, during dispensing, and then again after the bulk product has been dispensed into the receptacle container 105. It will be appreciated that the weight of the cartridge 104 that is being measured in real-time as the bulk product is being dispensed can be constantly compared to the weight of the cartridge 104 before the bulk product is dispensed. This constant comparison allows the system to track the weight of the bulk product being dispensed by subtracting the weight of cartridge 104 in real-time from the weight of the cartridge 104 before dispensing. The scale can also be used to measure the difference in the cartridge weight before and after dispensing so that the difference and weight information can be relayed to inventory, point of sale, and transaction fee databases, as described below. The scale can provide real-time information for each transaction. Although the system is described as measuring the weight or mass of the cartridge 104 storing the bulk product, it will be appreciated that the scale may instead or also measure the weight of the full automatic dispenser 100 before, during and after dispensing, for determining the weight or mass of the dispensed bulk product.

By measuring or calculating the weight of the cartridge 104, the automatic product dispensing system can efficiently and accurately determine the mass or weight of the dispensed bulk product, without relying on the weight or mass of the dispensed product in the receptacle container 105. A user should not be able to access the cartridge 104 or the bulk product directly from the cartridge 104, as the cartridge 104 may be housed in the frame 112 which may be only accessible by the retailer, as described above. A user may potentially tamper with the weight of the dispensed product in the receptacle container 105, and so by measuring the weight of the cartridge 104, the risk of the user stealing bulk product by tampering with the weight of the receptacle container may be avoided.

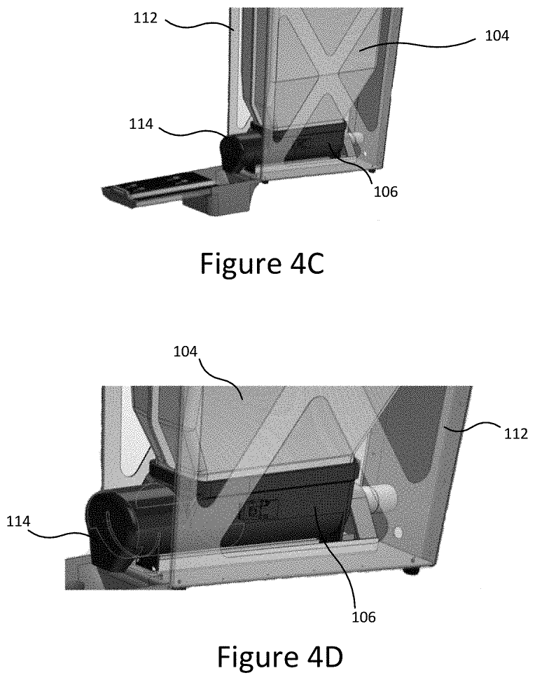

FIGS. 5A and 5B depict an embodiment of the automatic dispenser 200. The automatic dispenser 200 comprises a display 202 and a cartridge 204 for storing the bulk product. The cartridge 204 may comprise a gravity feed system 208 at a bottom of the cartridge 204, as described above, to aid in dispensing the bulk product. The cartridge 204 connects to an auger chamber 206 or a valve system for dispensing the bulk product through the end funnel 214. The auger chamber 206 may be removable from the frame 212 of the automatic dispenser 200, as described above, and may connect to the frame 212 via a coupler 210. Although the cartridge 204 and the auger chamber 206 are depicted as being removable, it will be appreciated that the auger chamber 206 and/or the cartridge 204 may be securely attached to the frame 212. In such a case, the cartridge 204 may be refilled by removing or opening a cover on a top or a side of the cartridge 204, and the coupler 210 may be the motor for engaging rotation of the auger to dispense the bulk product.

The automatic dispenser 200 may further comprise a platform 216. When a user would like to dispense product from the automatic dispenser 200, they may place their receptacle container on the platform 216 before the system starts dispensing bulk product. The platform 216 may be positioned under the end funnel 214 so that the receptacle container can receive the bulk food product being dispensed. The platform 216 may comprise a platform scale to weigh the receptacle container and its contents before, during and/or after the bulk product is dispensed, as described below. The platform 216 may further comprise an elevation adjustment system 218 for adjusting the platform height to accommodate different receptacle container sizes. Once the user has placed the receptacle container on the platform 216, the platform height may be adjusted using the elevation adjustment system 218 so that the top of the receptacle container is positioned closer to or farther from the bottom of the end funnel 214. The elevation adjustment system 218 may use a ball screw mechanism driven by a stepper motor to allow for accurate adjustment of the platform height. The ball screw may be controlled by user input when no receptacle container is registered by the system. It will be appreciated that the although the elevation adjustment system 218 is described as using a ball screw mechanism, the elevation system 218 may instead use another mechanism for adjusting the position of the platform 216.

The automatic dispenser 200 may further comprise a scale to measure the weight or mass of the cartridge 204 storing the bulk product to measure or calculate the weight or mass of the dispensed bulk product, similar to automatic dispenser 100. As described above, the scale may weigh the cartridge 204, that stores the bulk product, before the bulk product is dispensed, during dispensing, and then again after the bulk product has been dispensed into the receptacle container. The weight of the cartridge 204 that is being measured in real-time as the bulk product is being dispensed can be constantly compared to the weight of the cartridge 204 before the bulk product is dispensed. This constant comparison allows the system to track the weight of the bulk product being dispensed by subtracting the weight of cartridge 204 in real-time from the weight of the cartridge 204 before dispensing.

It will be appreciated that the automatic dispenser 200 may instead or further use the platform scale to measure or calculate the weight or mass of the dispensed bulk product. The platform scale may measure or calculate the weight of the receptacle container before, during, and after dispensing to determine the weight or mass of the dispensed bulk product. Using the platform scale, the automatic dispensing system may weigh the receptacle container before any bulk product is dispensed so that during the dispensing process, the total weight of the receptacle container and the bulk product dispensed into the receptacle container being measured during dispensing may be constantly compared to the weight of the empty receptacle container. This constant comparison allows the system to track the weight of the bulk product being dispensed by subtracting the weight of the empty receptacle container, from the total weight of the receptacle container and the bulk product dispensed into the receptacle container being measured. It will be appreciated that for the constant comparison, the platform scale may instead be zeroed once the receptacle container is placed on the platform 216. In this way, the weight of the empty receptacle container is not used for the constant comparison and instead only the weight of the dispensed product is tracked. These systems all for the consumer to not be charged for the weight of their receptacle container, only for the weight of the bulk product they are purchasing. The platform scale may be a load cell or internal strain gauge that sends an analogue value to the main system based on platform weight or mass.

It will be appreciated that in some embodiments, both the weight of the container 204 and the weight of the receptacle container may be measured and constantly compared. Using two scales together would allow the system to track that the dispensed product is being properly captured by the user's receptacle container and prevent product spilling onto the floor.

The automatic dispensing system may use the analogue value of one or both of the scales to calculate a real-time mass value in grams, where the total mass being measured by the scale or by the platform scale is constantly compared to the mass of the cartridge 204 before dispensing or the empty receptacle container, respectively. The analogue value may be determined from a sensor associated with the scale and/or platform scale and may be amplified by a Wheatstone bridge circuit. The value is then sent to a slave device. As described above, the comparison may subtract the mass of the cartridge 204 after dispensing or the mass of the empty receptacle container from the mass of the cartridge 204 during dispensing or the total mass of the receptacle container and the dispensed product during the dispensing, respectively, to ensure the desired amount of bulk product is dispensed.

In another embodiment, instead of or in addition to measuring the weight of the empty receptacle container or of the cartridge 104, 204, when an auger is used to dispense the bulk product, the amount of rotations that the auger makes may be registered and may be compared to the analog value of the strain gauge of the scale in the frame 112, 212 or in the platform 216. This comparison may be used to ensure that the desired amount of bulk product is dispensed into the receptacle container. This can aid in eliminating theft of the bulk product and in determining if the auger is jammed during dispensing, or if the automatic dispenser 100, 200 is out of bulk product.

As described above, the automatic dispenser 100, 200 comprises a display 102, 202. The display 102, 202 may be an easy to use user interface to allow consumers to identify and purchase bulk product within a 5-10 second target per transaction. The display 102, 202 may be placed at the front of the automatic dispenser 100, 200 or may be placed in a spot where the user has easy access to it. The interface may be a digital interface to allow the user to dispense the bulk product and to control the starting and stopping of the dispensing. The interface can allow the user to provide an indication to the system to dispense the bulk product via a button or a digital interface, as described below. The display 102, 202 may be an E paper screen that saves energy for the system when not in use.

In some embodiments, when the automatic dispenser is not in use, the automatic dispenser may enter a sleep type mode. This means that while the display is not in use, it may be dark, in a dormant mode using no energy. This allows energy to be saved while the automatic dispenser is not in use. When the automatic dispenser in a sleep type mode, it may be activated by the user to start or light up the display to allow for the dispensing of the bulk product. To activate the system, the user may use an identification means by tapping an activator on the automatic dispenser. The activator may be placed below or near the display to allow for easy activation of the dispensing system. The activator may be a RFID reader or other similar identification reader.

The identification means (also considered as the “identification key”) may be a wireless means such as a designated key fob or RFID key, the user's credit card using the magnetic stripe or tapping functions, a visual means such as the user's customer identification card where a barcode or other type of identification may be scanned by the activator, or another similar identification means. Other similar identification means may include, but are not limited to, an application on a smart phone, and a bio-identification means such as a finger print or retina scan. Each consumer may have their own single identification key to activate and record all transactions performed with the one or more automatic bulk product dispensers. The identification key may use a software system to store the measured weight or mass of the dispensed bulk product and may also store a corresponding price for each of the bulk products that were dispensed for the user. In an embodiment, the identification key may convert the mass or weight into a monetary value and store the monetary value for payment purposes. By storing the prices of the dispensed products, when the user arrives at the cash register or checkout, the identification key can be scanned to identify the amount and cost of the user's dispensed bulk products.

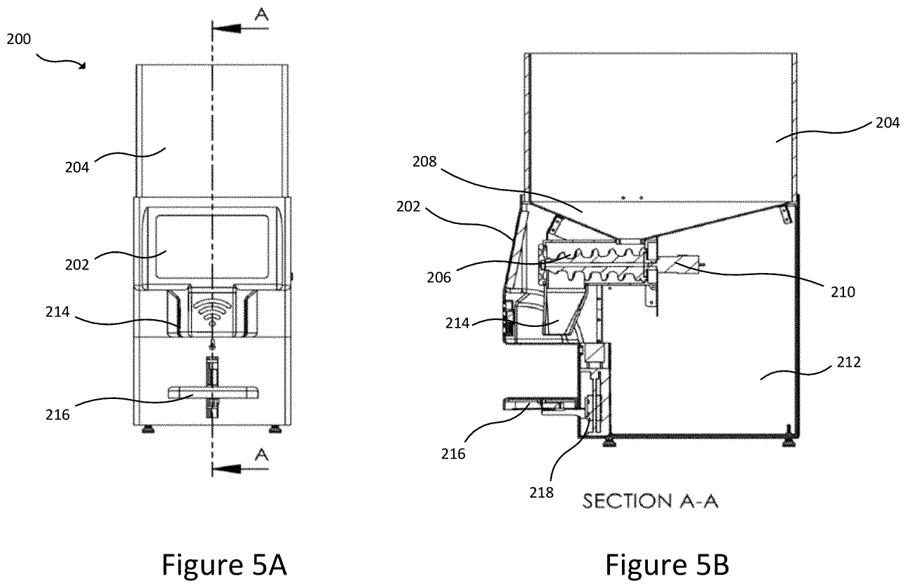

FIGS. 6A and 6B depict an embodiment of a display 602 of the automatic dispenser 100, 200. The display 602 may display (603) the price of the bulk product per a unit of mass, or a unit of measurement such as grams, kilograms, cups, tablespoons, teaspoons, millilitres, etc. The display 602 may comprise a button 604 for receiving an indication to start and stop the dispensing process. The user can press the button 604 to start the dispensing process and then press the button 604 again to stop the dispensing process. Alternatively, the user may press and hold the button 604 to dispense the bulk product and then release the button 604 to stop the dispensing. Before the user presses the button 604, the receptacle container should be placed or held under the end funnel 114, 214.

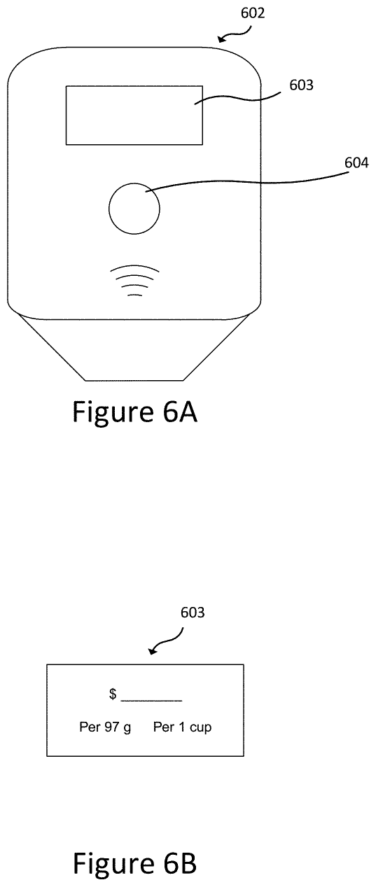

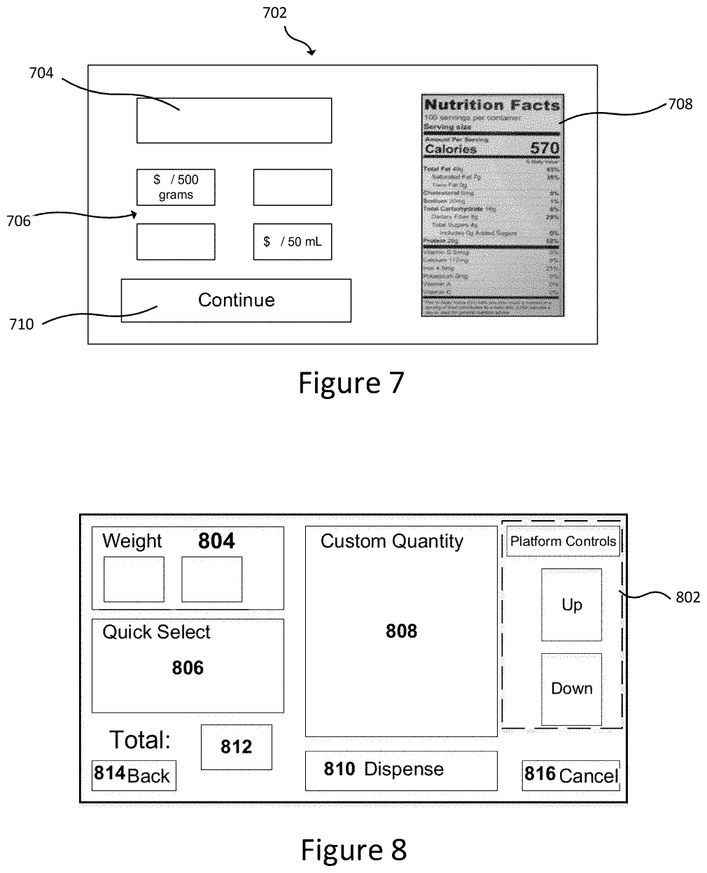

FIG. 7 depicts an embodiment of a display 702 of the automatic dispenser 100, 200. The display 702 may depict nutritional information of the bulk product for the user, the time and date, and may allow the consumer to specify the desired amount of product to be dispensed (as will be described with reference to FIG. 8). As shown in FIG. 7, the nutritional information may include the name of the bulk product 704, the pricing system 706 for the bulk product, and the nutritional facts 708. The pricing system 706 may include the pricing for the product based on its volume (e.g. in cups or in millilitres), and the price of the product based on its weight (e.g. ounces) or mass (e.g. grams). The nutritional facts 708 may depict the facts of the bulk product based on a specific weight or volume. The facts may include the calories, fat content, cholesterol content, sodium content, protein content, and more. The nutritional information display may help the user in deciding if they would like to purchase the bulk product, or how much of the product they should purchase. If the user would like to purchase the bulk product type shown on the nutritional information page, they may tap a “Continue” or “Begin” type button 710 on the display 702. The display 702 may then prompt the user to press a button similar to button 604 to start and stop the dispensing or may prompt the user to select their desired quantity of the bulk food product as shown in FIG. 8.

FIG. 8 depicts dispensing options for an embodiment of the display of the automatic dispenser 100, 200. In embodiments where the automatic dispenser 200 comprises a platform 216, the display may comprise platform controls 802. The user can adjust the height of the platform 216 with the elevation adjustment system 218 using the platform controls 802. When the user is placing their receptacle container on the platform 216, if the receptacle container does not properly fit in the platform slot, the user can use the platform controls 802 to adjust the platform height. The elevation adjustment system 218 is controlled by the platform controls 802 on the display 202, however it will be appreciated that a separate set of controls on the automatic dispenser 200 may instead be used. If the elevation adjustment system 218 is controlled by a separate set of controls in the form of a second digital interface or physical buttons, the platform height may be adjusted before, during, or after the nutritional information is depicted on the display, or while the user is selecting their desired amount of bulk product. When the elevation adjustment system 218 is controlled by the platform controls 802 on the display 202, the platform height may be adjusted after the user has tapped the “Continue” or “Begin” button 710. Although the platform controls 802 are described as being a separate set of controls or as being on present on the display after the user has tapped button 710, it will be appreciated that instead the display 702 may further comprise the platform controls so that the user may adjust the platform height before tapping the “Continue” or “Begin” type button 710.

As depicted in FIG. 8, the user may be prompted to select their desired amount of bulk product to be dispensed by weight, mass or volume 804, price 806, a custom quantity 808, or by free dispense (similar to button 604). A user may select their desired amount of product by weight, mass or volume 804 based on a predetermined weight, mass or volume. The predetermined weight, mass or volume may be set by the retailer based on the popular dispensing amounts, or may be preprogrammed into the system. The display may also allow the user to select the desired amount of product by price 806 based on a predetermined price list that may be set by the retailer based on the popular dispensing amounts, or may be preprogrammed into the system. The display may also allow the user to enter in a custom quantity 808 for the desired amount of product to be dispensed based on a desired weight, mass, volume, or price. The value of the desired amount of bulk product and the desired measurement units may be inputted by the user onto the display using the dispensing options described above.

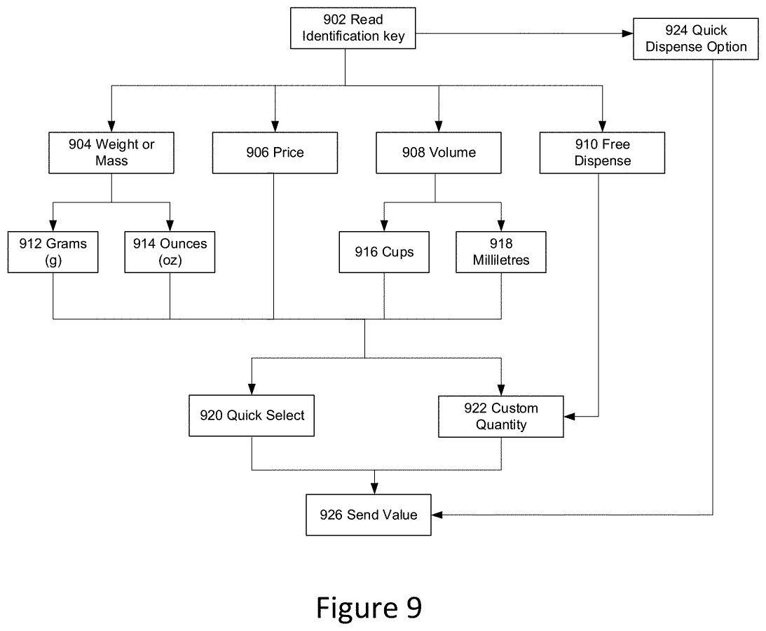

FIG. 9 depicts a system for selecting a desired amount of bulk product through a master device. The process of the master device may be activated when an identification key has been used with the activator (902). As described above, the user may select their desired bulk product amount based on weight or mass 904, price 906, volume 908, or they may use a free dispense option 910. If the user selects their desired amount based on weight or mass 904, they may select the weight or mass as for example, grams 912, ounces 914, or another weight or mass unit. If the user selects their desired amount based on volume 908, they may select the volume as for example, cups 916, millilitres 918, or another volume unit. Based on the selected measurement unit (e.g. mass/weight 904, price 906, or volume 908), the user can select the desired amount based on a quick select option 920 with predetermined weight or mass 904, price 906, or volume 908 values. The user may also have the option to select a custom quantity 922 of the bulk product based on their selected measurement unit.

The user may also have the option to select the free dispense 910 to dispense their desired amount of bulk product. When using this option, a measurement unit for the amount of dispensed product may not be selected by the user. The free dispense option 910 may be used to dispense product until the user's receptacle container is full or until the user is satisfied with the amount of bulk product. This option will be further described below.

The user may also have the option to select the desired amount to be dispensed by a quick dispense option 924. The quick dispense option 924 may include one or more set weight, mass, price, or volume values based on the predetermined values described above. Once the user has selected their desired amount using one of the measurement units or using the quick dispense option 924, the value for the selected amount of bulk product to be dispensed may be sent (926) to the slave device. If the user has selected to dispense the product using the free dispense option 910, when the user indicates to start the dispensing, the indication to start dispensing the bulk product may be sent (926) to the slave device.

With reference to FIG. 8, if the user has selected their desired amount of bulk product, via the measurement units or via the quick dispense option, they can then tap the “Dispense” button 810 on the display and the corresponding amount of product would dispense into the receptacle container. Once the user taps the “Dispense” button 810, the chosen value is enabled to be sent to the slave device, as describe above. The “Dispense” button 810 may allow the system to receive the indication to start dispensing the bulk product. The system may convert the weight or mass amount into a monetary value and display the corresponding monetary value or price 812 of the selected amount. In this way, the user may edit their selected desired amount if the displayed price 812 is over or under the user's budget. Alternatively, if the user would like to review the nutritional information again before the bulk product starts dispensing, they may tap a “Back” button 814, or if the user decides they no longer desire any of the bulk product type to be dispensed by the particular automatic dispenser, they may tap a “Cancel” button 816 to stop the system and return to the home page of the display.

Once the user has selected their desired amount of bulk product, and the desired amount of product has been inputted onto the display, the user may tap the “Dispense” button 810 to start the dispensing process. The system will stop dispensing the product once the desired amount of the bulk product has been dispensed into the receptacle container.

If the user has selected to dispense the bulk product using the free dispense option 910, with reference to FIG. 6A, the user may use the button 604 as described above to start and stop the dispensing of the bulk product. With reference to FIG. 8, the user may press the “Dispense” button 810 to start and stop the dispensing of the bulk product. Once the user has pressed the button 604 or the button 810, an indication to start dispensing the bulk product may be sent to the slave device. It will be appreciated that the user may press the button 604, 810 to start and to stop the dispensing process or the user may press and hold the button 604, 810 until the desired amount of bulk product has been dispensed into their receptacle container.

When the user starts the dispensing process by pressing the button 604 or the “Dispense” button 810, for the free dispense option or for a pre-selected amount of bulk product, an indication is sent to the system of the automatic dispenser to activate or engage the motor to engage the auger or valve system. As described above, before the motor is activated, the system may measure or weigh the weight or mass of the cartridge 104, 204 using the scale in the frame 112, 212, or may measure or weigh the receptacle container using the scale in the platform 216.

If the user has selected a desired amount of bulk product to be dispensed, the real-time scale value is constantly compared to the desired scale value while power is applied to the motor for the auger or valve. The desired scale value may be determined by the system through the corresponding weight or mass, price, or volume selected by the user. The system then constantly checks the scale value in real-time to determine if the desired scale value has been reached. For example, if the scale measures the weight or mass of the cartridge 104, 204, the system may check for the desired scale value as the difference between the total weight or mass of the cartridge 104, 204 before dispensing and the real-time weight or mass of the cartridge 104, 204 as the product is being dispensed. If the scale measures the weight or mass of the receptacle container, the system may check for the desired scale value as the difference between the weight or mass of the empty receptacle container and the real-time weight or mass of the receptacle container as the bulk product is dispensed into it. Once the desired scale value is met, the system sends an indication or an interrupt to stop the power to the motor that is engaged with the auger or valve. It will be appreciated that the indication or interruption may stop the auger from rotating or may close the valve.

During the dispensing of the selected amount of the bulk product, if the user notes that the amount being dispensed seems to be more than what the receptacle container can receive, the user may tap the “Dispense” button 810 or the “Cancel” button 816 to stop the dispensing, similar to the free dispense option. The system may then use the comparison similar to the free dispense option, where the weight or mass of the cartridge 104, 204 or the receptacle container before dispensing is compared to the weight or mass after dispensing, to calculate or determine the new amount, and price for the dispensed bulk product.

If the user does not select a desired amount of product and instead uses the free dispense option, the indication to stop powering the motor for the auger or valve or interruption to stop the power to the motor is sent when the “Dispense” button 810 or button 604 is pressed or tapped for a second time. It will be appreciated that if the user is instead pressing and holding the button 604, 810, the indication to stop or interrupt the motor is sent when the “Dispense” button 810 or button 604 is released. When the dispensing is stopped or interrupted, the scale measures the cartridge 104, 204 or the receptacle container after the bulk product has been dispensed. The system may then compare the measured weight or mass of the cartridge 104, 204 or the receptacle container before dispensing, to the measured weight or mass after dispensing. For example, the amount of bulk product that has been dispensed may be determined or calculated by the system from the difference of the weight or mass of the cartridge 104, 204 before dispensing to the weight or mass of the cartridge 104, 204 after dispensing. Similarly, the amount of bulk product that has been dispensed may be determined or calculated by the system from the difference between the weight or mass of the receptacle container after the bulk product has been dispensed and the weight or mass of the receptacle container before any dispensing has occurred. While the bulk product is being dispensed into the receptacle container, the scale is also measuring the weight or mass of the cartridge 104, 204 or the receptacle container. This real-time calculated or determined mass or weight of the dispensed bulk product is converted, using integrated software, to the corresponding monetary and volume values. These values may be displayed and updated on the display as the bulk product is being dispensed so that the user can see the amount and cost of bulk product they are receiving in real-time.

As described above, when an auger is used to dispense the bulk product, the amount of rotations that the auger makes may be registered and may be compared to the analog value of the strain gauge of the scale in the frame 112, 212 or in the platform 216. The scale value that is read by the system may also or instead be constantly compared to the amount of rotations made by the auger during dispensing. If the number of rotations made by the auger does not match the typical number of rotations for the scale value being read for the dispensed product, the automatic dispenser may be out of bulk product, or there may be a problem with the scale or auger. In this case, an alert may be sent by the system to an online database and the dispensing may be halted.

The automatic dispensing system is able to automatically dispense the desired amount of bulk product for a user into a receptacle container using the comparison systems of the automatic dispenser 100, 200 described above. The comparison systems may be performed by a processor of the automatic dispenser 100, 200. The processor may also display the comparison or the amount of bulk product being dispensed in real-time on the display.

The automatic dispenser 100, 200 may further comprise an infrared sensor on or near the platform 216 or below the end funnel 114, 214, which may be used to detect the presence of a receptacle container so that the bulk product is dispensed only when a receptacle container is present. If the infrared sensor does not sense a receptacle container on the platform 216 or below the end funnel 114, 214, the automatic dispenser will not dispense any of the bulk product.

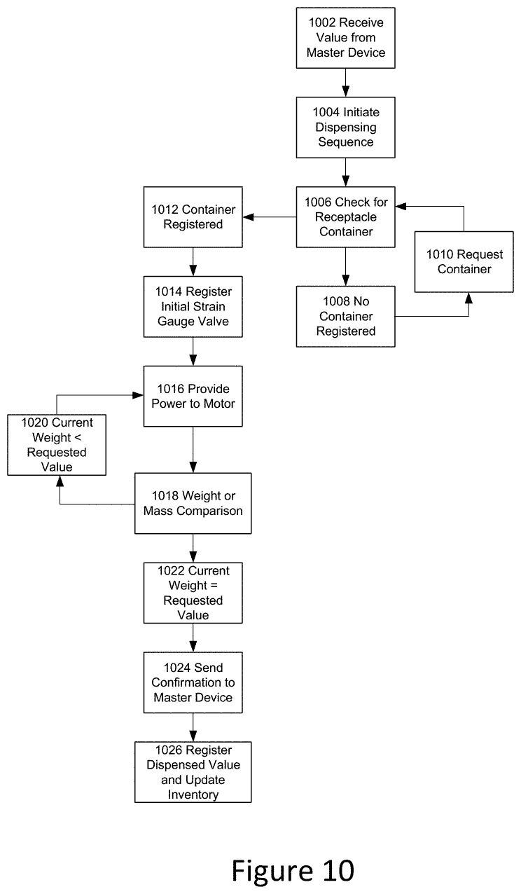

FIG. 10 depicts a dispensing system of the automatic dispenser 100, 200, when the user selects the desired amount of bulk product as described above. With reference to FIG. 9, after the user has selected their desired amount of bulk product, the master device sends the value (926) to the slave device. The slave device may then receive this value (1002) and may initiate a dispensing sequence for the bulk food product (1004). If the automatic dispenser 100, 200 comprises an infrared sensor, the sensor checks to ensure there is a receptacle container below the end funnel 114, 214, or on the platform 216 (1006), before the motor is engaged or activated. This is to ensure that no bulk product is wasted by being dispensed without a receptacle container present. If the sensor does not sense that a receptacle container is present (1008), a notification may be displayed on the display of the automatic dispenser 100, 200, requesting that a receptacle container be positioned to receive bulk product (1010). If the automatic dispenser 200 comprises a platform 216, the system may request that the platform 216 be raised with the elevation adjustment system 218 (1010). This raising of the platform 216 may be done in case the receptacle container is on the platform 216 but is too low for the sensor to sense. The sensor may then check for a receptacle container again (1006). This checking process may be repeated until a receptacle container is sensed on the platform 216 or under the end funnel 114, 214.

When the sensor has registered that a container is present (1012), the platform scale measures and registers the strain gauge value of the empty receptacle container and/or the scale in the frame 112, 212 measures and registers a strain gauge value of the cartridge 104, 204 (1014). The motor may then be activated to power the auger or valve (1016), so that the auger rotates or the valve opens and allows the bulk product to dispense into the receptacle container. As the bulk product is being dispensed, the system is constantly checking if the desired amount of product has been dispensed. This checking may be done by subtracting the strain gauge value of the empty receptacle container from the real-time weight value of the receptacle container and dispensed product, or by subtracting the real-time strain gauge value of the cartridge 104, 204 from the strain gauge value of the cartridge 104, 204 before the dispensing started (1018). When the real-time or current weight value is less than the desired weight value (1020), the system continues to provide power to the motor of the auger or valve (1016). When the current weight value is equal to the desired weight value (1022), the motor stops providing power to the auger or valve so that the bulk product stops being dispensed. The platform 216 may then be lowered to ensure the receptacle container can be removed from the platform 216, and a confirmation may be sent to the master device (1024). The confirmation is sent to notify the master device that the desired amount of bulk product has been dispensed. The weight value of the dispensed amount may then be registered and can be used to update an online database (1026).

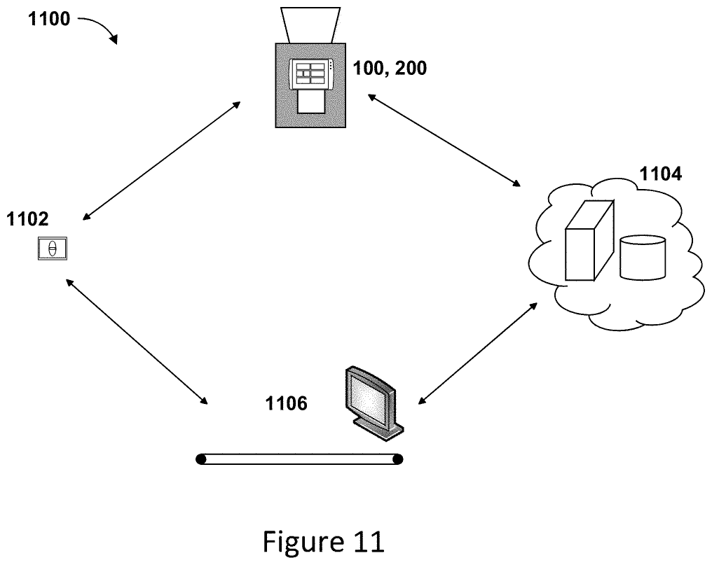

FIG. 11 depicts a dispensing system 1100 using an identification key 1102. As described above, the system of the automatic dispenser 100, 200 may be activated using an identification key 1102. It will be appreciated that the automatic dispenser 100, 200 may be activated by a user identification number or password inputted on the display, a finger print identification system, or another identification means instead of a physical identification key. Once the bulk product has been dispensed into the receptacle container of the user, a price value is converted from the corresponding weight or mass of the dispensed bulk product. The price value may be converted using the processor of the automatic dispenser 100, 200. The price may be determined based on a price per weight, price per mass, or price per another measurement unit.

When the dispensing process of the automatic dispenser 100, 200 has stopped, the weight or mass of the dispensed bulk product and the corresponding price calculated by the system, may be uploaded to an online database 1104, or stored to an internal software, with a reference to the associated identification key 1102 or identification means that was used to activate the automatic dispensing system. It will be appreciated that the information may be stored, uploaded, and transmitted using a cloud system, the internet, or a network system. The weight or mass of the final dispensed product and the corresponding price calculated by the system may also be stored on a memory of the identification key 1102. This information may also be recorded to an inventory database, a point of sale online database, and a transactional fee database. A processor may be used to transmit the information to the memory or databases. The system may also use the selected or determined weight or mass of the dispensed product to update the information in a bulk product inventory which may be stored in the online database 1104 and may contain inventories for each bulk product sold by the retailer through multiple automatic dispensers 100, 200. The update of the bulk product inventories may be done by the system of the automatic dispenser 100, 200 communicating with the bulk product inventory over the online database 1104. The online database 1104 may be part of a centralized database system accessible via an online website, or may be stored internally. The inventory database may pull data from the scale of the automatic dispenser 100, 200 that measures the weight or mass of the cartridge 104, 204 and store the information internally or online for the inventory of the bulk products. The software of the automatic dispenser 100, 200 may allow for the mass or weight of the dispensed bulk product to be subtracted from the inventory database after each transaction, and can allow the updated inventory amount to be stored after each transaction. In the case of the online database, each retailer may be able to create or access their own account through a website where they would be able to view the database 1104 and other information about their automatic dispenser(s) 100, 200. The website may store product and equipment statuses and information. In this way, the retailer can always be aware of the amount of bulk product being dispensed and the amount of bulk product remaining in the cartridge 104, 204 using the information in the bulk product inventory. This allows the retailer to be aware of the exact quantity of bulk food product remaining in each of the dispensing cartridges 104, 204 in real-time.

When the desired amount of bulk product has been dispensed from one or more automatic dispensers 100, 200, the user may go to a cash register or checkout 1106 at the store provided by the retailer. At the checkout 1106 the user may scan their identification key 1102 or input their identification means. This allows the costs and amounts of the dispensed bulk products dispensed for the user to be transmitted, via a server, from the online database 1104 or from the collected purchases on the memory of the identification key 1102 to the checkout system, or to be called from the internal software storage means. The database 1104 may store the dispensed product information with reference to the particular user or particular identification key 1102. The cashier or retailer is not required to read and weigh the products and codes from manually scooped bulk products, but will instead be able to view, on the monitor of the cash register or checkout 1106, the amount of bulk products that were dispensed and the corresponding cost of the dispensed products from the information stored in the database 1104, on the memory of the identification key 1102, or in the internal storage means. This information can be used to tabulate the user's total bill in lieu of scanning individual items.

The system of the automatic dispenser 100, 200 may be integrated into the retailer's cash register or checkout system, or the action of scanning the identification key 1102 may be used to output the value of the customer's dispensed bulk product(s) to the retailer's cash register or checkout employee. This value may then be manually input into the retailer's cash register or checkout system by the store employee if the identification key 1102 is scanned.

The checkout system can add the costs of each of the dispensed bulk products together to determine a total cost for the user's bulk products. This total cost or final bill for the user may be paid at the checkout 1106 by any payment means, or may be paid using payment information that may be stored on the identification key 1102 of the user. In another embodiment, the cost of the dispensed bulk product may be paid at the automatic dispenser 100, 200. For example, the identification key 1102 may be used to activate the automatic dispensing system, and once the system has finished dispensing the bulk product, the corresponding cost may be displayed on the display. The user can then pay for the dispensed bulk product using payment information stored on the identification key 1102 or using a card type payment means at the automatic dispenser 100, 200. In this case, the automatic dispenser 100, 200 may comprise sensors for processing the payment means of the user.

It will be appreciated that the dispensing system may further comprise a unique point of sale system that plugs in or is installed on a vendor's or retailer's sales system (for example, a cash register or checkout). Information about the dispensed products and costs for the transactions may be communicated via a cloud, internet, or network to the point of sale system and the identification key 1102. A separate tablet may be used for the point of sale system that may interact with the customer and can be plugged in or amalgamated with the vendor's or retailer's overall point of sale system. The identification key can communicate with the online, cloud, or network. This system can speed up customer check outs by enabling a single tap transaction for payment over the traditional scanning if every item purchased.

The system of the automatic dispenser 100, 200 may also include a transactional calculation for revenue dispersion for the owner or retailer. The information for performing the transactional calculation and the transactional fee may be stored on the transactional database in the internal software or online. The transactions at the automatic dispensers 100, 200 may all be stored in monetary value on the databases so that a pre-determined percentage of each transaction can be allocated to the owner of the automatic dispenser(s) 100, 200. The transactional calculation may be done based on a profit margin of the bulk product being dispensed. This information about the profit margin may be input into the system by the retailer or may be a predetermined value on the website. The transactional fee may be determined based on a percentage. This allows the automatic dispenser units 100, 200 to be replaced at no cost to the retailer for rental.

The internal software may also collect consumer data to allow the retailer to analyze information regarding which items are purchased together, typical quantities of the bulk product that is dispensed, personal information on the consumers (if provided) and other consumer information about the dispensed products. This information can be used to arrange products in store to facilitate consumer patterns or used for marketing purposes.

Overall the benefits for the automatic dispenser 100, 200 include, but are not limited to, no cross contamination of food, exact dispensing of desired quantities, facilitating the purchasing process for food products in bulk, reducing plastic and food waste, the user may purchase a desired quantity rather than a pre-packed quantity, the consumer may have better budget control, and the bulk products can have a prolonged product shelf life.

The automatic dispenser 100, 200 may perform the mass, weight, and price calculations, determinations, and measurements using a processor or an integrated software system. The processor or integrated software system may communicate with servers and databases to transmit and store dispensed product information. The integrated software may be integrated into the system to do one or more of the following: record and tally customer transactions, communicate with store point of sale software, communicate with inventory database, provide data and analytics to the retailer, and/or record transactional disbursements to the dispenser owners.

The main systems of the invention may comprise a software code to control one or more of the calibration of the system, the adjustment of the platform height for the receptacle container, the start and stop of the motors in the system, the bulk product dispensing, the strain gauge measurements, the Wheatstone bridge circuit, and the calculation of the amount of bulk product dispensed and corresponding cost.

The automatic dispenser 100, 200 may be used for grocery or retail shoppers, grocery retailers, vending machines, and many other applications.

It will be apparent to persons skilled in the art that a number of variations and modifications can be made without departing from the scope of the invention. Although specific embodiments are described herein, it will be appreciated that modifications may be made to the embodiments without departing from the scope of the current teachings. Accordingly, the scope of the invention should not be limited by the specific embodiments set forth, but should be given the broadest interpretation consistent with the teachings of the description as a whole.

What is claimed is:

1. A method of automatically dispensing a bulk product, the method comprising:
receiving an indication to dispense bulk product;
measuring a weight of a bulk product bin before dispensing;
automatically dispensing at least a portion of the bulk product from the bulk product bin;
measuring a weight of the bulk product bin after dispensing; and
displaying a difference between the weight of the bulk product bin before dispensing and the weight of the bulk product bin after dispensing to a display.

2. The method of claim 1, further comprising receiving identification information identifying the user.

3. The method of claim 2, further comprising storing the difference and the identification information to a database.

4. The method of claim 1, wherein the indication to dispense bulk product includes an amount of the bulk product to be dispensed.

5. The method of claim 4, wherein the amount of the bulk product is provided in a unit of measure, and the method further comprises automatically converting the amount of bulk product to be dispensed into a weight or mass of the bulk product to be dispensed.

6. The method of claim 1, wherein the difference is transmitted to a database for updating an inventory of the bulk product.

7. The method of claim 1, further comprising:
automatically converting the difference into a corresponding cost for the at least a portion of the bulk product;
storing the difference and the corresponding cost to a database; and
displaying the cost on the display.

8. The method of claim 7, wherein the cost and the difference are transmitted and stored on the database to update an inventory of the bulk product.

9. An automatic dispensing apparatus comprising circuitry configured to perform the method of claim 1.

10. A checkout system for purchasing automatically dispensed bulk product, the system comprising:
a retrieving unit for retrieving information, from a database, about at least one dispensed bulk product associated with a user, the information comprising a cost of each of the at least one dispensed bulk product; and
a processor for determining a total cost of the at least one dispensed bulk product based on the cost of each of the at least one dispensed bulk product, and displaying the total cost to a display.

11. The system of claim 10, wherein the information further comprises a type of the at least one bulk product and an amount of the at least one bulk product.

12. The system of claim 10, further comprising a receiver for receiving an indication from an identification key of the user to retrieve the information.

13. An apparatus comprising:
a bulk product bin configured to store bulk product;
a dispensing chamber removably attached to the bulk product bin and configured to dispense at least a portion of the bulk product;
a scale at a bottom of the bulk product bin to measure a weight of the bin before and after the at least a portion of the bulk product has been dispensed.

14. The apparatus of claim 13, wherein the dispensing chamber comprises a valve system for dispensing the at least a portion of the bulk product.

15. The apparatus of claim 13, wherein the dispensing chamber comprises an auger system for dispensing the at least a portion of the bulk product.

16. The apparatus of claim 13, further comprising a display configured to display a difference between the weight of the bin before and the weight of the bin after the at least a portion of the bulk product has been dispensed.
